(19) United States
(12) Patent Application Publication
(10) Pub. No.: US 2025/0140036 A1
(43) Pub. Date: May 1, 2025

(54) RAPID DATA ANALYTICS FOR ENGINES WITH INTEGRATION TO SERVICE TEAM / SERVICE DEALER

(71) Applicant: Cummins Inc., Columbus, IN (US)

(72) Inventors: Prasanna Pramod Tagare, Pune (IN); Lalit Sudhakar Chaudhari, Greenwood, IN (US); Parul Jain, Kharadi (IN)

(73) Assignee: Cummins Inc., Columbus, IN (US)

(21) Appl. No.: 18/838,593

(22) PCT Filed: Feb. 16, 2023
(86) PCT No.: PCT/US2023/013228

§ 371 Date: Aug. 14, 2024

(30) Foreign Application Priority Data
Feb. 17, 2022 (IN) 202241008409

(51) Int. Cl. G07C 5/08; G07C 5/00

(52) U.S. Cl. CPC G07C 5/0816; G07C 5/006; G07C 5/008

(57) ABSTRACT

Systems and methods for data analysis of vehicle data, such as engine data, are provided. A provider computing system includes a communication interface structured to couple to a network, one or more processors, and at least one memory storing instructions that, when executed by the one or more processors, cause the one or more processors to perform operations. The operations include: receiving, from a user device and via the network, a first data packet comprising information associated with a vehicle. The operations also include analyzing the first data packet to output a second data packet comprising repair priority information. The operations also include transforming the second data packet into a human-readable message comprising the repair priority information. The operations also include transmitting, via the communication interface and the network, the human-readable message to the user device.

### CROSS-REFERENCE TO RELATED APPLICATION

This PCT Application claims the benefit of and priority to Indian Provisional Patent Application No. 202241008409, filed on Feb. 17, 2022, titled “RAPID DATA ANALYTICS FOR ENGINES WITH INTEGRATION TO SERVICE TEAM/SERVICE DEALER,” which is incorporated herein by reference in its entirety and for all purposes.

### TECHNICAL FIELD

The present disclosure relates to systems and methods for rapid data analysis of vehicle systems, such as engines.

### BACKGROUND

Owners of engine-powered systems such as automotive vehicles may periodically require maintenance for the automotive vehicles. The maintenance may include diagnosing vehicle problems and/or analyzing vehicle engine performance, determining a maintenance plan based on the diagnosis or analysis, and performing vehicle maintenance. During maintenance, the automotive vehicles are in “down time” where the automotive vehicles cannot perform working activities (e.g., hauling loads or freight, transportation, etc.). Improved systems and methods for diagnosis, analytics, and maintenance are desired to reduce vehicle/system downtime.

### SUMMARY

One embodiment relates to a provider computing system. The provider computing system includes a communication interface that is structured to communicatively couple to a network. The provider computing system also includes one or more processors and a memory storing instructions that, when executed by the one or more processors, cause the one or more processors to perform operations. The operations include receiving, from a user device and via the network, a first data packet. The first data packet includes information associated with a vehicle. The operations also include analyzing, by an engine performance analysis circuit, the first data packet. The engine performance analysis circuit may output a second data packet comprising repair priority information based on the analysis. The operations also include transforming, by the engine performance analysis circuit, the second data packet into a human-readable message. The human-readable message includes the repair priority information. The operations also include transmitting, by the communications interface and via the network, the human-readable message to the user device.

Another embodiment relates to a provider computing system. The provider computing system includes a communication interface structured to couple to a network, one or more processors, and at least one memory storing instructions that, when executed by the one or more processors, cause the one or more processors to perform operations. The operations include: receiving, from a user device and via the network, a first data packet comprising information associated with a vehicle; analyzing the first data packet to output a second data packet comprising repair priority information; transforming the second data packet into a human-readable message comprising the repair priority information; and transmitting, via the communication interface and the network, the human-readable message to the user device.

Still another embodiment relates to a method. The method includes: receiving, by a computing system and from a user device coupled to a vehicle based on receiving an authentication credential that authenticates the user device, a first data packet comprising information associated with the vehicle; analyzing, by the computing system, the first data packet; generating, by the computing system and based on analyzing the first data packet, a second data packet comprising repair priority information; transforming, by the computing system, the second data packet into a human-readable message comprising the repair priority information; and transmitting, by the computing system, the human-readable message to the user device.

Yet another embodiment relates to a non-transitory computer readable medium having computer-executable instructions embodied therein that, when executed by at least one processor of a computing system, cause the computing system to perform operations. The operations include: receiving a first data packet comprising information associated with a vehicle from a user device; analyzing the first data packet; generating a second data packet comprising repair priority information based on analyzing the first data packet; transforming the second data packet into a human-readable message comprising the repair priority information; and transmitting the human-readable message to the user device.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

FIG. 1 is a block diagram of a computing system for rapid data analysis, according to an example embodiment.

FIG. 2 is a block diagram of the vehicle of the system of FIG. 1, according to an example embodiment.

FIG. 3 is a flow diagram of a method of rapid data analysis by the system of FIG. 1, according to an example embodiment.

These and other features, together with the organization and manner of operation thereof, will become apparent from the following detailed description when taken in conjunction with the accompanying drawings.

### DETAILED DESCRIPTION

Following below are more detailed descriptions of various concepts related to, and implementations of methods, apparatuses, and systems for rapid engine field performance data analysis, also referred to herein as engine field performance analysis (“EFPA”). The various concepts introduced herein may be implemented in any number of was, as the concepts described are not limited to any particular manner of implementation. Examples of specific implementations and applications are provided primarily for illustrative purposes.

Referring to the Figures generally, the various embodiments disclosed herein relate to systems, apparatuses, and methods for rapid engine field performance analysis (EFPA). A controller (e.g., an engine control module (ECM), an engine control unit (ECU), and/or another electronic control unit) for a vehicle includes at least one processor and at least one memory storing instructions that, when executed by the processor, cause the controller to perform various operations. The operations include detecting one or more operational parameters of the vehicle such as an engine fuel economy, an average engine load, duty cycle information, operational information (e.g., average engine temperatures, pressures, etc.; fueling information; etc.), and/or other engine operational parameters. The one or more operational parameters may be transmitted to a remote (e.g., off-vehicle) computing system directly (e.g., via a network) or indirectly (e.g., via a user device). In an example embodiment, the one or more operational parameters are first transferred to a user device and then transmitted to the remote computing system over a network. The remote computing system may analyze the one or more operational parameters and determine one or more maintenance parameters for the vehicle. The maintenance parameters may include preventative maintenance, repairs to damaged parts, adjustments to parts that are performing out of specification (e.g., above a maximum threshold or below a minimum threshold). The remote computing system may transform the data to a human-readable message and provide the human-readable message to a user (e.g., a repair technician). The rapid EFPA is advantageously performed within a predetermined amount of time (e.g., within four hours, within 90 minutes, and so on).

The systems, apparatuses, and methods disclosed herein relate to and/or are further capable of performing operations including detecting, sensing, predicting, or otherwise determining operational parameters of a vehicle. As used herein the term “operational parameter” and similar terms are used to mean an operational state, a control method or sequence, and/or other parameter of a vehicle. Thus, the operational parameter may include settings for the vehicle or a system thereof (e.g., maximum allowable amount of emissions before a derate occurs, maximum torque allowed, etc.) as well as operational characteristics of the vehicle or a system/component thereof (e.g., engine temperatures during certain operating conditions, duty cycle information, etc.). The operational parameter may take the form a numeric, alpha, alphanumeric, and/or other type of data structure. The operational parameter may be detected or sensed by an actual sensor (e.g., real sensor), determined by a virtual sensor based on one or more other acquired data (e.g., a calculation by a processor), determined by comparing data to a lookup table, determined using one or more statistical models (e.g., a regression model, a machine learning model, etc.), and/or another method or process described herein. Examples of operational parameters may include, but are not limited to: a fuel-air mixture ratio, a cruise control (CC) droop amount, a transmission shift schedule, a maximum allowed engine speed, a maximum torque, a maximum power delivery, maximum values before a derate condition (e.g., throttle and/or boost time), a fuel consumption rate (e.g., per mile, per time period, etc.), and/or other operational parameters associated with a vehicle. The operational parameters may also include engine, powertrain information, and/or aftertreatment system such as engine performance data including, but not limited to, efficiency of one or more components or systems (e.g., SCR, DOC, DPF, other catalysts, other systems and/or components such as a turbocharger), temperatures (e.g., exhaust gas and intake air temperatures), pressures (e.g., charge, DPF, etc.).

As used herein the term “operational data” and similar terms are used to mean machine-readable and/or human-readable data that includes one or more operational parameters. The operational data may, in some embodiments, include metadata such as a vehicle or engine identifier, a timestamp, a geo-location stamp, and/or other suitable metadata. Accordingly, sensors may sense or detect operational data including one or more operational parameters, and a processor may transform the detected or determined operational data or parameter to include the metadata.

The systems and methods described herein provide a technical solution to a technical problem of determining a maintenance plan (or general diagnosis and/or prognosis information) for a vehicle. For example, in any of the above embodiments, the remote computing system may advantageously reduce the amount of time required to generate and provide the maintenance plan to a technician by reducing the amount of data sent back to the user device in the form of a human-readable message. The human-readable message is advantageously a small file size allowing the maintenance plan to be quickly transmitted to the user device even on a low-bandwidth signal. The maintenance plan advantageously mitigates against engine damage by recommending preventative maintenance, repairs, and/or adjustments based on actual engine performance data (e.g., the one or more operational parameters) rather than relying on a manufacturer recommendation in vehicles that may have different operating conditions, workloads, and/or other vehicle-to-vehicle variations. These and other features and benefits are described more fully herein below.

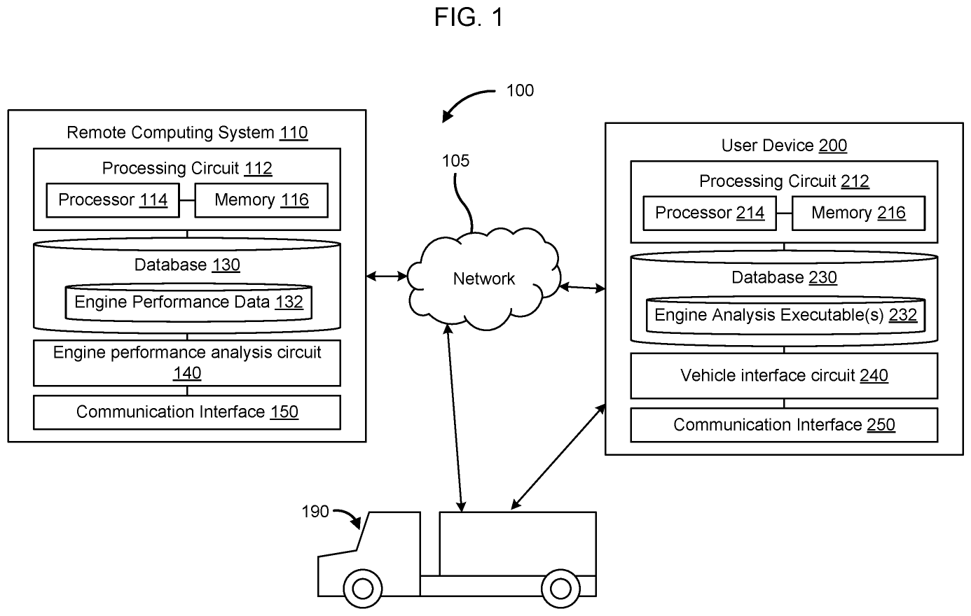

Referring now to FIG. 1, a block diagram of a system 100 for rapid data analysis is shown, according to an example embodiment. As shown in FIG. 1, the system 100 includes a network 105, a remote computing system 110, at least one vehicle shown as a first vehicle 190, and at least one user device shown as user device 200. Each of the components of the system 100 are in communication with each other and are coupled by the network 105. Specifically, the remote computing system 110, the computing and/or control systems of first vehicle 190, and/or the user device 200 are communicatively coupled to the network 105 such that the network 105 permits the direct or indirect exchange of data, values, instructions, messages, and the like (represented by the double-headed arrows in FIG. 1). In an example embodiment and as shown by the double headed arrow in FIG. 1, the first vehicle 190 is communicatively coupled to the user device 200 by a wired or wireless connection other than the network 105. In some arrangements, the network 105 is configured to communicatively couple to additional computing system(s). In operation, the network 105 facilitates communication of data between the remote computing system 110 and other computing systems associated with the service provider or with a customer or business partner of the service provider (e.g., a vehicle or vehicle fleet owner, a vehicle service/repair business, and the like) such as a user device (e.g., a mobile device, smartphone, desktop computer, laptop computer, tablet, or any other suitable computing system). The network 105 may include one or more of a cellular network, the Internet, Wi-Fi, Wi-Max, a proprietary provider network, a proprietary service provider network, and/or any other kind of wireless and/or wired network.

The remote computing system 110 is a remote computing system such as a remote server, a cloud computing system, and the like. Accordingly as used herein, “remote computing system” and “cloud computing system” are interchangeably used to refer to a computing or data processing system that has terminals distant from the central processing unit (e.g., processing circuit 112) from which users and/or other computing systems (e.g., the user device 200 and/or computing/control systems of the vehicle 190) communicate with the central processing unit. In some embodiments, the remote computing system 110 is part of a larger computing system such as a multi-purpose server, or other multi-purpose computing system. In other embodiments, the remote computing system 110 is implemented on a third party computing device operated by a third party service provider (e.g., AWS, Azure, GCP, and/or other third party computing services).

The remote computing system 110 is operated by the service provider associated with the system 100. Accordingly, in some embodiments, the remote computing system 110 is a service and/or system/component provider computing system and in turn controlled by, managed by, or otherwise associated with service and/or system/component provider (e.g., an engine manufacturer, a vehicle manufacturer, an exhaust aftertreatment system manufacturer, etc.). In the example shown, the remote computing system 110 is operated and managed by an engine manufacturer (which may also manufacture and commercialize other goods and services). Accordingly, an employee or other operator associated with the service and/or system/component provider may operate the remote computing system 110.

As shown in FIG. 1, the remote computing system 110 includes a processing circuit 112, a database 130, one or more specialized processing circuits shown as an engine performance analysis circuit 140, and a communications interface 150. The processing circuit 112 is coupled to the specialized processing circuits, the database 130 and/or the communications interface 150. The processing circuit 112 includes a processor 114 and a memory 116. The memory 116 is one or more devices (e.g., RAM, ROM, Flash memory, hard disk storage) for storing data and/or computer code for completing and/or facilitating the various processes described herein. The memory 116 is or includes non-transient volatile memory, non-volatile memory, and non-transitory computer storage media. The memory 116 includes database components, object code components, script components, or any other type of information structure for supporting the various activities and information structures described herein. The memory 116 is communicatively coupled to the processor 114 and includes computer code or instructions for executing one or more processes described herein. The processor 114 is implemented as one or more application specific integrated circuits (ASICs), field programmable gate arrays (FPGAs), a group of processing components, or other suitable electronic processing components. As such, the remote computing system 110 is configured to run a variety of application programs and store associated data in a database and/or the memory 116.

The communications interface 150 is structured to receive communications from and provide communications to other computing devices, users, and the like associated with the remote computing system 110. The communications interface 150 is structured to exchange data, communications, instructions, and the like with an input/output device of the components of the system 100. In some arrangements, the communications interface 150 includes communication circuitry for facilitating the exchange of data, values, messages, etc. between the communications interface 150 and the components of the remote computing system 110. In some arrangements, the communications interface 150 includes machine-readable media for facilitating the exchange of information between the communications interface 150 and the components of the remote computing system 110. In some arrangements, the communications interface 150 includes any combination of hardware components, communication circuitry, and machine-readable media.

In some embodiments, the communications interface 150 includes a network interface. The network interface is used to establish connections with other computing devices by way of the network 105. The network interface includes program logic that facilitates connection of the remote computing system 110 to the network 105. In some arrangements, the network interface includes any combination of a wireless network transceiver (e.g., a cellular modem, a Bluetooth transceiver, a Wi-Fi transceiver) and/or a wired network transceiver (e.g., an Ethernet transceiver). For example, the communications interface 150 includes an Ethernet device such as an Ethernet card and machine-readable media such as an Ethernet driver configured to facilitate connections with the network 105. In some arrangements, the network interface includes the hardware and machine-readable media sufficient to support communication over multiple channels of data communication. Further, in some arrangements, the network interface includes cryptography capabilities to establish a secure or relatively secure communication session in which data communicated over the session is encrypted. Accordingly, the remote computing system 110 may be structured to facilitate encrypting and decrypting data sent to and from the remote computing system 110. For example, the remote computing system 110 may be structured to encrypt data transmitted by the communications interface 150 to other devices on the network 105, such as the user device 200. Encrypting data may include transforming digital data using one or more mathematical techniques, along with a unique token (e.g., password, key, etc.). Decrypting data may include transforming encrypted digital data using one or mathematical techniques and the unique token to return the digital data to a readable state. Various methods of encrypting and/or decryption may be used including public-key encryption, symmetric key encryption, etc.

In an example embodiment, the communications interface 150 is structured to receive information from the user device 200 and provide the information to the components of the remote computing system 110 over the network 105. The communications interface 150 is also structured to transmit data from the components of the remote computing system 110 to the user device 200.

The memory 116 may store a database 130, according to some arrangements (alternatively, the database 130 may be separate from the memory 116). The database 130 retrievably stores data associated with the remote computing system 110 and/or any other component of the system 100. That is, the data includes information associated with each of the components of the system 100. For example, the data includes information about one or more vehicle such as the first vehicle 190. The information about the first vehicle 190 includes engine performance data 132. The engine performance data 132 includes information received from user device 200 and/or metadata including information about the first vehicle 190. For example, the engine performance data 132 includes location information such as a vehicle location and/or a vehicle distance traveled. The engine performance data 132 also includes engine performance information such as fuel consumption information such as an engine fuel consumption rate, a total fuel consumption over a predetermined time period or distance, and so on. The engine performance data 132 also includes engine performance information such as engine work time, engine idle time, engine exhaust data (e.g., exhaust gas/particle concentration), and/or other engine operational parameters. The metadata may also include an engine serial number, a vehicle identification number (VIN), a calibration identification and/or verification number, a software identification, a make of the vehicle, a model of the vehicle, a unit number of a power unit of the vehicle, a unique identifier regarding a controller of the vehicle (e.g., a unique identification value (UID)), and/or a vehicle maintenance history. Any of the data described above may include additional metadata such as a timestamp of when the data was gathered and/or when the data was transmitted or received by the remote computing system 110. The predetermined time periods described above may include a trip time, a work cycle (e.g., day, week, month, etc.), a time period between vehicle service, a predetermined vehicle lifespan, and the like. Accordingly, any of the information described above may include corresponding metadata.

The database 130 also stores user device information associated with the user device 200 such as customer information including a number of vehicles owned, fleet identifiers, one or more vehicle identifiers, data reporting preferences, vehicle maintenance history. The user device information may also include a user device registration, a user device ID, a user device software registration, a user device software ID, and/or other identifiers for identifying the user device 200 and/or software on the user device 200. The data stored by the database 130 is retrievable, viewable, and/or editable by the remote computing system 110 (e.g., by a user input).

The database 130 may be configured to store one or more applications and/or executables to facilitate tracking data (e.g., vehicle data, fleet data, and/or user device data), managing real-time incoming data, generating or updating statistical models, or any other operation described herein. In some arrangements, the applications and/or executables are incorporated with an existing application in use by the remote computing system 110. In some arrangements, the applications and/or executables are separate software applications implemented on the remote computing system 110. The applications and/or executables may be downloaded by the remote computing system 110 prior to its usage, hard coded into the memory 116 of the processing circuit 112, or be a network-based or web-based interface application such that the remote computing system 110 provides a web browser to access the application, which may be executed remotely from the remote computing system 110 (e.g., by a user device). Accordingly, the remote computing system 110 includes software and/or hardware capable of implementing a network-based or web-based application. For example, in some instances, the applications and/or executables include software such as HTML, XML, WML, SGML, PHP (Hypertext Preprocessor), CGI, and like languages.

In the latter instance, a user (e.g., a provider employee, a customer, etc.) may log onto or access the web-based interface before usage of the applications and/or executables. In this regard, the applications and/or executables are supported by a separate computing system including one or more servers, processors, network interface, and so on, that transmit applications for use to the remote computing system 110.

In one embodiment, and as shown in FIG. 1, the remote computing system 110 includes an engine performance analysis circuit 140 that includes any combination of hardware and software for analyzing engine performance data such as the engine performance data 132 stored by the database 130. The engine performance analysis circuit 140 is structured to analyze the engine performance data 132 and, based the engine performance data 132 (e.g., vehicle operational data, vehicle metadata, etc.) and/or predetermined parameters associated with one or more vehicles, determine whether a vehicle parameter (e.g., the vehicle 190) is exceeding a threshold parameter. For example, the remote computing system 110 is structured to receive data from the user device 200, and via the communications interface 150. The received data is stored in the database 130 (e.g., with the engine performance data 132). The engine performance analysis circuit 140 determines, based on the engine performance data 132, whether one or more operational parameters of the vehicle 190 exceeds a threshold of the respective parameter. The operational parameters may include an emission value (e.g., a nitrous-oxide value, a carbon dioxide value, a particulate matter value, etc.), an engine knock value, a fuel consumption value, and/or other parameters related to the operation of the vehicle 190. Based on determining that one or more of the operational parameters exceed a threshold (e.g., above a maximum value, below a minimum value) the engine performance analysis circuit 140 may determine a corrective action to bring the operational parameter within the threshold (e.g., below the maximum, above the minimum). Based on determining the corrective action, the engine performance analysis circuit 140 may transform the engine performance data 132 into a human-readable message that includes the corrective action and transmit the human-readable message to the user device 200. The human-readable message advantageously is a low band-with message. For example, the human-readable message may only include text (e.g., without images). Accordingly, the engine performance analysis circuit 140 receives, engine performance data 132, analyses the engine performance data 132 and transforms the engine performance data into a human readable message.

The first vehicle 190 is a vehicle having a power unit such as an engine (e.g., a diesel engine, an internal combustion engine, a hybrid engine, an electric engine, etc.) or other power unit such as a battery, a fuel cell, etc. In some embodiments, the first vehicle 190 is part of a fleet that includes one or more vehicles. In some embodiments, the system 100 includes more vehicles than the first vehicle 190. For example, the system 100 may include all the vehicles in the fleet. The first vehicle 190 and/or the fleet is associated with at least one of the service provider, a direct customer of the service provider, a third party customer, a location (e.g., a city, a state, a region, a country, etc.), a vehicle type (e.g., engine type, chassis type, workload type, etc.), and/or any other parameter associated with the vehicle 190 or fleet. For example, the first vehicle 190 and/or the fleet may be associated with a first customer, and may include one or more vehicles.

The user device 200 is a user computing device such as a laptop computer, a desktop computer, a tablet, a smartphone, and the like. In some embodiments, the user device is configured as a scan tool configured to communicably couple to the first vehicle 190. In some embodiments, the user device may be embodied in both a user computing device and a scan tool. The scan tool may connect to a port (e.g., a wired connection) on the vehicle to extract operational parameters stored by the vehicle (e.g., controller). Accordingly as used herein, “user device” is used to refer to a computing or data processing system and/or a handheld scanning device for use by a user. In some embodiments, the user device 200 is associated with a customer or business partner of the service provider associated with the remote computing system 110. In other embodiments, the customer and/or business partner is associated with a vehicle service/repair facility, a vehicle dealership, and/or other third party business. The third party business may have a physical location where a vehicle, such as the first vehicle 190, may be serviced or repaired. Accordingly and in the example shown, the user device 200 may be a computing system for the service/repair facility. Accordingly, an employee or other operator (e.g., technician or other personnel) associated with the service/repair facility may operate the user device 200.

As shown in FIG. 1, the user device 200 includes a processing circuit 212, a database 230, one or more specialized processing circuits shown as a vehicle interface circuit 240, and a communications interface 250. The processing circuit 212 is coupled to the specialized processing circuits, the database 230 and/or the communications interface 250. The processing circuit 212 includes a processor 214 and a memory 216. The memory 216 is one or more devices (e.g., RAM, ROM, Flash memory, hard disk storage) for storing data and/or computer code, such as instructions, for completing and/or facilitating the various processes described herein. The memory 216 is or includes non-transient volatile memory, non-volatile memory, and non-transitory computer storage media. The memory 216 includes database components, object code components, script components, or any other type of information structure for supporting the various activities and information structures described herein. The memory 216 is communicatively coupled to the processor 214 and includes computer code or instructions for executing one or more processes described herein. The processor 214 is implemented as one or more application specific integrated circuits (ASICs), field programmable gate arrays (FPGAs), a group of processing components, or other suitable electronic processing components. As such, the user device 200 is configured to run a variety of application programs and store associated data in a database and/or the memory 216.

The communications interface 250 is structured to receive communications from and provide communications to other computing devices, users, and the like associated with the user device 200. The communications interface 250 is structured to exchange data, communications, instructions, and the like with an input/output device of the components of the system 100. For example, the communication interface 250 is structured to receive a user input via one or more input devices such as a keyboard, a touchscreen, etc. and provide an output via one or more output device such as a display, a speaker, etc. In some arrangements, the communications interface 250 includes communication circuitry for facilitating the exchange of data, values, messages, etc. between the communications interface 250 and the components of the user device 200. In some arrangements, the communications interface 250 includes machine-readable media for facilitating the exchange of information between the communications interface 250 and the components of the user device 200. In some arrangements, the communications interface 250 includes any combination of hardware components, communication circuitry, and machine-readable media.

In some embodiments, the communications interface 250 includes a network interface. The network interface is used to establish connections with other computing devices by way of the network 105. The network interface includes program logic that facilitates connection of the user device 200 to the network 105. In some arrangements, the network interface includes any combination of a wireless network transceiver (e.g., a cellular modem, a Bluetooth transceiver, a Wi-Fi transceiver) and/or a wired network transceiver (e.g., an Ethernet transceiver). For example, the communications interface 250 includes an Ethernet device such as an Ethernet card and machine-readable media such as an Ethernet driver configured to facilitate connections with the network 105. In some arrangements, the network interface includes the hardware and machine-readable media sufficient to support communication over multiple channels of data communication. Further, in some arrangements, the network interface includes cryptography capabilities to establish a secure or relatively secure communication session in which data communicated over the session is encrypted. Accordingly, the user device 200 may be structured to facilitate encrypting and decrypting data sent to and from the user device 200. For example, the user device 200 may be structure to encrypt data transmitted by the communications interface 250 to other devices on the network 105, such as the remote computing system 110.

In an example embodiment, the communications interface 250 is structured to receive information from the vehicle interface circuit 240 transmit the information to the remote computing system 110. The communications interface 150 is also structured to receive data from the remote computing system 110 and provide the data to the components of the user device 200.

The memory 216 may store a database 230, according to some arrangements (alternatively, the database 230 may be separate from the memory 216). The database 230 retrievably stores data associated with the user device 200 and/or any other component of the system 100. That is, the data includes information associated with each of the components of the system 100. For example, the data includes information about one or more vehicle such as the first vehicle 190.

The database 130 may be configured to store one or more applications and/or executables to facilitate tracking data (e.g., vehicle data, fleet data, and/or user device data), managing real-time incoming data, generating or updating statistical models, or any other operation described herein. In some arrangements, the applications and/or executables are incorporated with an existing application in use by the remote computing system 110. In some arrangements, the applications and/or executables are separate software applications implemented on the remote computing system 110. The applications and/or executables may be downloaded by the remote computing system 110 prior to its usage, hard coded into the memory 116 of the processing circuit 112, or be a network-based or web-based interface application such that the remote computing system 110 provides a web browser to access the application, which may be executed remotely from the remote computing system 110 (e.g., by a user device). Accordingly, the remote computing system 110 includes software and/or hardware capable of implementing a network-based or web-based application. For example, in some instances, the applications and/or executables include software such as HTML, XML, WML, SGML, PHP (Hypertext Preprocessor), CGI, and like languages.

In the latter instance, a user (e.g., a provider employee, a customer, etc.) may log onto or access the web-based interface before usage of the applications and/or executables. In this regard, the applications and/or executables are supported by a separate computing system including one or more servers, processors, network interface, and so on, that transmit applications for use to the remote computing system 110.

In an example embodiment, the database 230 stores engine analysis executables 232. The engine analysis executables 232 includes executables (e.g., software) for communicatively coupling to and/or retrieving data from a vehicle such as the first vehicle 190. For example, the processing circuit 212 may execute the engine analysis executables 232 and communicatively couple (e.g., via the vehicle interface circuit 240) to the first vehicle 190. The engine analysis executables 232 may cause the user device 200 (e.g., the processing circuit 212 and/or the vehicle interface circuit 240) to retrieve data, including engine performance data, from the first vehicle 190.

In some embodiments, the engine analysis executables 232 include a mobile application for the user device 200. For example, a user may execute an engine analysis executable 232 to launch a mobile application for enabling the user device to communicably couple to and/or retrieve data from the vehicle 190. In these embodiments, the engine analysis executables 232 may cause the user device to generate a user interface. The user interface may display, for example, an indication that the user device 200 has successfully communicably coupled to the vehicle 190, an indication that the user device 200 is receiving data from the vehicle 190, and/or an indication that the user device 200 has completed a data transfer from the vehicle 190 (among potentially other indications).

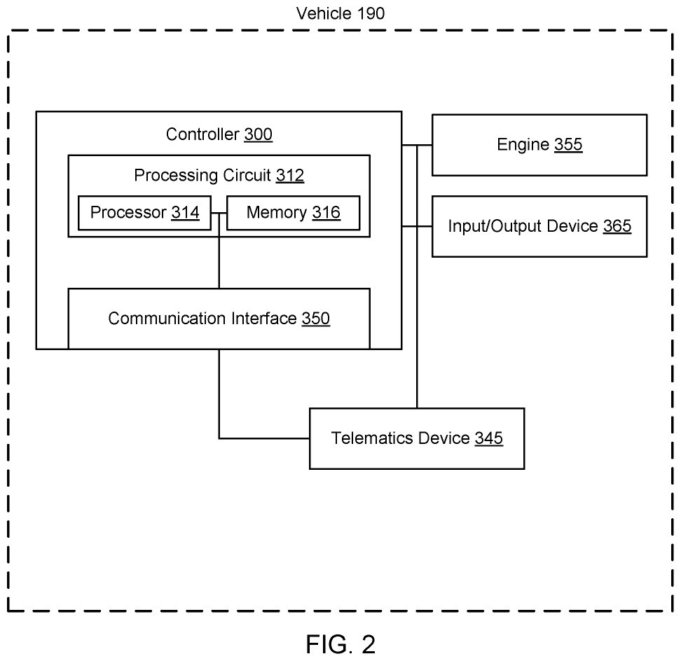

As briefly described above, the user device 200 may be configured as a scan tool structured to communicatively couple to the first vehicle 190. In these embodiments, the scan tool may have all the capabilities of the user device 200 described herein. The scan tool may be structured to physically connect to a vehicle controller, such as the controller 300 of FIG. 2 and/or a port on the first vehicle 190. In additional and/or alternative embodiments, the scan tool may wirelessly communicatively couple to the first vehicle 190. In some embodiments, the user device 200 includes both a user computing device and the scan tool (i.e., separate computing devices). In these embodiments, the user computing device may enable the scan tool to communicably couple to the vehicle 190 and scan the vehicle 190 for vehicle data.

In some embodiments, and as shown in FIG. 1, the remote computing system 110 includes a vehicle interface circuit 240 that includes any combination of hardware and software for communicatively coupling the user device 200 with a vehicle, such as the first vehicle 190. The vehicle interface circuit 240 is structured to communicatively couple to the first vehicle 190 by a wired or wireless connection. In some embodiments, the hardware and/or software of the vehicle interface circuit 240 may be embodied in the scan tool. The vehicle interface circuit 240 is further structured to retrieve engine performance data from a computing/control system of the vehicle 190 (e.g., the controller 300 of FIG. 2). In some embodiments, the engine performance data is in a computer-readable format. In some embodiments the engine performance data is in a non-human-readable format.

FIG. 2 is a block diagram of a vehicle 190 of the system 100 of FIG. 1, according to an example embodiment. The vehicle 190 is any type of passenger or commercial automobile, such as a commercial on-road vehicle including but not limited to, a line haul truck (e.g., a semi-truck, a school bus, a garbage truck, etc.); a non-commercial on-road vehicle, such as a car, truck, sport utility vehicle, cross-over vehicle, van, minivan, automobile; an off-road vehicle, such as tractor, airplane, boat, forklift, front end loader, etc.; and/or any other type of machine or vehicle that is suitable for the systems described herein. In some embodiments, the vehicle may be a stationary vehicle (e.g., a generator, an air compressor, etc.

The vehicle 190 is shown to include an engine 355. The engine 355 may be any type of internal combustion engine, such as a gasoline, natural gas, and/or diesel engine, and/or any other suitable engine. In some embodiments, the engine 355 may be embodied in a hybrid engine system (e.g., a combination of the internal combustion engine and an electric motor). In other embodiments, the engine 355 is excluded and an only an electric engine is included with the vehicle (e.g., a full electric vehicle where power may come from a fuel cell, one or more batteries, etc.). In the example shown, the engine 355 is a diesel-powered compression-ignition engine. The engine 355 includes one or more cylinders and associated pistons whereby the one or more cylinders may be arranged in a variety of ways (e.g., v-arrangement, inline, etc.). Air from the atmosphere is combined with fuel, and combusted, to produce power for the vehicle. Combustion of the fuel and air in the compression chambers of the engine 355 produces exhaust gas that is operatively vented to an exhaust pipe and to, in some embodiments, an exhaust aftertreatment system. While not shown, the vehicle 190 may also include additional systems, such as the exhaust aftertreatment system, a lubrication system, a hydraulic system, and/or other systems.

The vehicle 190 is also shown to include a controller 300. The controller 300 may be structured as one or more vehicle controllers/control systems, such as one or more electronic control units. The controller 300 may be separate from or included with at least one of a transmission control unit, an exhaust aftertreatment control unit, a powertrain control module, an engine control module or unit, or other vehicle controllers. In one embodiment, the components of the controller 300 are combined into a single unit. In another embodiment, one or more of the components may be geographically dispersed throughout the system or vehicle. In this regard, various components of the controller 300 may be dispersed in separate physical locations of the vehicle 190. All such variations are intended to fall within the scope of the disclosure.

The vehicle 190 includes a sensor array that includes a plurality of sensors. The sensors are coupled to the controller 300, such that the controller 300 can monitor, receive, and/or acquire data indicative of operation of the vehicle 190 (which may be referred to as operational data associated with the vehicle, operational parameters, and similar terms herein). In this regard, the sensor array may include one or more physical (real) or virtual sensors. For example, the sensor array may include temperature sensors. The temperature sensors acquire data indicative of or, if virtual, determine an approximate temperature of various components or systems, such as the exhaust gas at or approximately at their disposed location. The sensor array may also include an emissions sensor that acquire data indicative of or, if virtual, determine an approximate amount or concentration of emissions in the exhaust gas stream at or approximately at their disposed locations (e.g., immediately downstream of the engine 355, immediately downstream of the aftertreatment system, etc.). A speed sensor is configured to provide a speed signal to the controller 300 indicative of a vehicle speed. In some embodiments, there may be a sensor that provides a speed of the vehicle (e.g., miles-per-hour) while in other embodiments the speed of the vehicle may be determined by other sensed or determined operating parameters of the vehicle (e.g., engine speed in revolutions-per-minute may be correlated to vehicle speed using one or more formulas, a look-up table(s), etc.). The sensor array may also include a fuel tank level sensor that determines a level of fuel in the vehicle 190, such that a fuel economy may be determined based on the speed of the vehicle relative to the fuel consumed by the engine 355 (i.e., to determine a distance-per-unit of fuel consumed, such as miles-per-gallon or kilometers-per-liter, etc.). Additional sensors may be used alone or in combination to determine a fuel economy for the vehicle 190 include, but are not limited to, an oxygen sensor, an engine speed sensor, a mass air flow (MAF) sensor, and a manifold absolute pressure sensor (MAP). Based on the foregoing, the controller 300 may determine a fuel economy for the vehicle 190 which may be provided to the operator via the I/O device 365.

The sensor array may include a flow rate sensor that is structured to acquire data or information indicative of flow rate of a gas or liquid through the vehicle (e.g., exhaust gas through an aftertreatment system or fuel flow rate through an engine, exhaust gas recirculation flow at a particular location, a charge flow rate at a particular location, an oil flow rate at various positions, a hydraulic flow rate at a particular location, etc.). The flow rate sensor(s) may be coupled to the engine 355, an aftertreatment system of the vehicle 190, and/or elsewhere in the vehicle 190.

The sensor array may further include any other sensors. Such sensors may be used to determine a duty cycle for the vehicle 190, and particularly, the engine 355. A duty cycle refers to a repeatable set of data, values, or information indicative of how the specific vehicle is being utilized for a particular application. In particular, a “duty cycle” refers to a repeatable set of vehicle operations for a particular event or for a predefined time period. For example, a “duty cycle” may refer values indicative of a vehicle speed for a given time period. In another example, a “duty cycle” may refer to values indicative of an aerodynamic load on the vehicle for a given time period. In yet another example, a “duty cycle” may refer to values indicative of a vehicle speed and an elevation of a vehicle for a given time period. In this regard and compared to a vehicle drive cycle, which is typically limited to time versus speed information, the term “duty cycle” as used herein is meant to be broadly interpreted and inclusive of vehicle drive cycles among other quantifiable metrics. Beneficially and based on the foregoing, the “duty cycle” may be representative of how a vehicle may operate in a particular setting, circumstance, or environment (e.g., a seventy-file mile stretch of a relatively flat freeway environment). In this regard, the vehicle duty cycle may vary greatly based on the vehicle (e.g., a two-door sedan vehicle versus a concrete mixer truck versus a refuse truck versus a semi-tractor trailer vehicle). Duty cycle parameters may include therefore, but are not limited to, average engine load for a predefined time period (which may be determined by a MAP sensor or other sensors), a fuel consumption rate per time (e.g., gallons-per-hour as determined by a fuel consumption sensor), a fuel economy per unit of time, a value indicative of an amount time that the vehicle is in an idle (i.e., not moving such as when the vehicle is in a park transmission setting), Based on the foregoing, the controller 300 may track a total operation time based on total engine hours (total time engine is/was on) which may then be demarcated by vehicle drive time (time engine was on and vehicle was moving as evidenced by a vehicle speed above a threshold amount, such as zero miles-per-hour), idle time (time engine is on but the vehicle is not moving), and other demarcation possibilities.

It should be understood that other different/additional sensors may also be included with the vehicle 190, such as an accelerator pedal position (APP) sensor, a pressure sensor, an engine torque sensor, a battery sensor, etc. Those of ordinary skill in the art will appreciate and recognize the high configurability of the sensors and their associated positions in the vehicle 190. The controller 300 is structured to provide the operational data to a communicatively coupled device (e.g., the remote computing system 110 and/or the user device 200) via the communications interface 350 or, in some embodiments, a telematics unit/device 345. In some embodiments, the controller 300 may provide certain data/information to the third party computing system (not shown).

The vehicle 190 may also include an operator input/output (I/O) device 365. The operator I/O device 365 may be coupled to the controller 300, such that information may be exchanged between the controller 300 and the I/O device 365, where the information may relate to one or more components of the vehicle 190 and/or one or more determinations of the controller 300. The operator I/O device 365 enables an operator of the vehicle 190 to communicate with the controller 300 and one or more components of the vehicle 190 of FIG. 1. For example, the operator input/output device 365 may include, but is not limited to, an interactive display, a touchscreen device, one or more buttons and switches, voice command receivers, etc. In this way, the operator input/output device 365 may provide one or more indications or notifications to an operator, such as a malfunction indicator lamp (MIL), etc. Additionally, the vehicle 190 may include a port that enables the controller 300 to connect or couple to a scan tool, such as a scan tool of the vehicle interface circuit 240, so that fault codes and other information regarding the vehicle may be obtained.

In one embodiment, the vehicle 190 includes a telematics device 345. In some embodiments, the telematics device 345 may communicatively couple to the user device 200 (e.g., by the vehicle interface circuit 240) and/or the remote computing system 110. The telematics unit/device 345 may include, but is not limited to, a location positioning system (e.g., global positioning system) to track the location of the vehicle (e.g., latitude and longitude data, elevation data, etc.), one or more memory devices for storing the tracked data, and one or more electronic processing units for processing the tracked data. In some embodiments, the telematics device 345 is coupled to a communications interface 350 for facilitating the exchange of data between the telematics unit and one or more remote devices (e.g., a provider/manufacturer of the telematics device, etc.). For example, the communications interface 350 may be structured to communicatively couple the telematics device 345 with the user device 200 (e.g., by the vehicle interface circuit 240) and/or the remote computing system 110. In this regard, the communications interface 350 may be configured as any type of mobile communications interface or protocol including, but not limited to, Wi-Fi, WiMAX, Internet, Radio, Bluetooth, ZigBee, satellite, radio, Cellular, GSM, GPRS, LTE, and the like. The telematics unit 345 may also be communicatively coupled to the controller 300 of the vehicle 190. The communication interface 350 may also be communicatively coupled to the controller 300. In other embodiments, the telematics unit 345 may be excluded and the controller 300 may couple directly to the user device 200 and/or the remote computing system 110 (e.g., via wired and/or wireless connections) and exchange information directly with those systems without the intermediary of the telematics unit 345.

The communication interface 350 may include any type and number of wired and wireless protocols (e.g., any standard under IEEE 802, etc.). For example, a wired connection may include a serial cable, a fiber optic cable, an SAE J1939 bus, a CAT5 cable, or any other form of wired connection. In comparison, a wireless connection may include the Internet, Wi-Fi, Bluetooth, ZigBee, cellular, radio, etc. In one embodiment, a controller area network (CAN) bus including any number of wired and wireless connections provides the exchange of signals, information, and/or data between the controller 300, the telematics device 345, and/or the communication interface 350. In still another embodiment, the communication between the components of the vehicle 190 (e.g., the controller 300, telematics device 345, and the communication interface 350) is via the unified diagnostic services (UDS) protocol.

As alluded to above, the controller 300 may be structured to include the entirety of the communication interface 350 or include only a portion of the communications interface 350. In these latter embodiments, the communication interface 350 is communicatively coupled to the processing circuit 312. In other embodiments, the controller 300 is substantially separate from the communication interface 350. For example, the controller 300 and the communication interface 350 are separate control systems, but may be communicatively and/or operatively coupled. The communications interface 350 may include any combination of wired and/or wireless interfaces (e.g., jacks, antennas, transmitters, receivers, transceivers, wire terminals) for conducting data communications with various systems, devices, or networks structured to enable in-vehicle communications (e.g., between and among the components of the vehicle) and, in some embodiments (e.g., when the telematics unit 345 is excluded) out-of-vehicle communications (e.g., directly with user device 200 and/or the remote computing system 110). In this regard, in some embodiments, the communications interface 350 may include a network interface. The network interface is used to establish connections with other computing devices by way of the network 105. The network interface includes program logic that facilitates connection of the controller 300 to the network 105. The network interface includes any combination of a wireless network transceiver (e.g., a cellular modem, a Bluetooth transceiver, a Wi-Fi transceiver) and/or a wired network transceiver (e.g., an Ethernet transceiver). Thus, in some arrangements, the network interface includes the hardware and machine-readable media sufficient to support communication over multiple channels of data communication. Further, in some arrangements, the network interface includes cryptography capabilities to establish a secure or relatively secure communication session in which data communicated over the session is encrypted. For example and regarding out-of-vehicle/system communications, the communications interface 350 may include an Ethernet card and port for sending and receiving data via an Ethernet-based communications network and/or a Wi-Fi transceiver for communicating via a wireless communications network. The communications interface 350 may be structured to communicate via local area networks and/or wide area networks (e.g., the Internet) and may use a variety of communications protocols (e.g., IP, LON, Bluetooth, ZigBee, radio, cellular, near field communication). Furthermore, the communications interface 350 may work together or in tandem with a telematics unit in order to communicate with other vehicles in the fleet of one or more vehicles. In one example embodiment, the communications interface 350 is structured provide vehicle operational parameters and data to the user device 200.

In the example shown, the controller 300 includes a processing circuit 312 having a processor 314 and a memory device 316. The processing circuit 312 may be configured to execute or implant the instructions, commands, and/or control processes described herein.

The processor 314 may be implemented as one or more processors, one or more application specific integrated circuits (ASIC), one or more field programmable gate arrays (FPGAs), a digital signal processor (DSP), a group of processing components, or other suitable electronic processing components. The one or more processors may be shared by multiple circuits. Alternatively or additionally, the one or more processors may be configured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure. The memory device 316 (e.g., RAM, ROM, Flash Memory, hard disk storage, etc.) may store data and/or computer code for facilitating the various processes described herein. The memory device 316 may be communicably coupled to the processor 314 to provide computer code or instructions to the processor 314 for executing at least some of the processes described herein. Moreover, the memory device 316 may be or include tangible, non-transient volatile memory or non-volatile memory. Accordingly, the memory device 316 may include database components, object code components, script components, or any other type of information structure for supporting the various activities and information structures described herein.

In some embodiments, the controller 300 is configured as an on-board computing device (e.g., onboard the vehicle 190) that captures data including vehicle operational parameters. As one example, the controller 300 is communicatively coupled to the telematics device 345 such that the controller 300 causes the telematics device to detect, by one or more sensors, the vehicle operational parameters described herein. In another example, the controller 300 receives operational parameters directly via one or more sensors onboard the vehicle. In yet another example, the controller 300 receives operational parameters and determines operational parameters from information from the telematics unit 345, information from real sensors onboard the vehicle, and determined from information from sensors onboard the vehicle. The controller may store the data (e.g., in the memory device 316). The controller 300 provides the data to the user device 200 by communicatively coupling to the user device by the communication interface 350, the vehicle interface circuit 240, and/or the communication interface 250. In yet another embodiment, the functionality of the controller 300 may be split between the controller 300, the telematics device 345, and/or other components of the vehicle 190. All such variations are intended to fall within the scope of the disclosure.

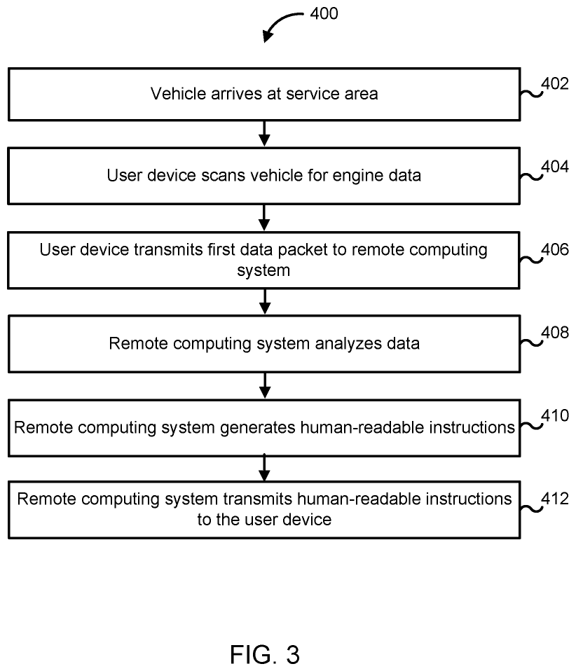

Referring now to FIG. 3, a flow diagram of a method 400 of rapid data analysis by the system of FIG. 1 is shown, according to an example embodiment. In some embodiments, one or more of the computing systems of the system 100 is configured to perform method 400. For example, the remote computing system 110, the user device 200, and/or the controller 300, may be structured to perform, at least parts thereof, the method 400. In the depicted example embodiment, the remote computing system 110 performs the method 400, alone or in combination with other devices such as the user device 200 and the controller 300. The method 400 may include user inputs from a user (e.g., a provider employee, a third-party employee, a customer, a vehicle operator, etc.) via one or more user devices (such as devices of provider employees, customer, a user device integrated with a vehicle, etc.), such as the user device 200.

As an overview of method 400, at process 402, a vehicle 190 arrives at a service area. At process 404, the user device 200 scans the vehicle 190 for engine data (e.g., the operational data described herein). At process 406, the user device 200 transmits a first data packet to the remote computing system 110. At process 408, the remote computing system 110 analyzes the first data packet. At process 410, the remote computing system 110 generates human-readable instructions. At process 412, the remote computing system 110 transmits the human-readable instructions to the user device 200. In some arrangements, the processes of the method 400 may be performed in a different order than as shown in FIG. 3 and/or the method 400 may include more or fewer steps than as shown in FIG. 3.

Referring to the method 400 in more detail, at process 402, a vehicle 190 arrives at a service area/location. The vehicle 190 may be operated by a vehicle operator. The service area/location may be part a predetermined area of a repair/service provider. The repair/service provider may be associated with the vehicle owner (e.g., as the same business, as separate businesses in a partnership, and so on). In other embodiments, the service location may be unaffiliated with the vehicle operator. In still some other embodiments, the service location may be associated with the remote computing system 110. Upon entry, an operator of the vehicle may convey information (e.g., issues, healthy workings, etc.) associated with the vehicle to a technician who may enter this information into the user device 200.

At process 404, the user device 200 scans the vehicle 190 for vehicle data, such as engine data. The user device 200 is structured to communicatively couple (e.g., via the vehicle interface circuit 240) with the vehicle 190 (e.g., the controller 300 and/or the telematics device 345). The user device 200 may scan the vehicle 190 for vehicle operational data including engine data. That is, the user device may cause the vehicle 190 (and/or components thereof) to transmit vehicle operational data to the user device 200. For example, the user device 200 may physically or wirelessly connect to the vehicle 190. In either of these embodiments, the user device 200 may transmit instructions to the controller 300 and/or the telematics device 345 that cause the controller 300 and/or the telematics device 345 to provide the vehicle data to the user device 200. In some embodiments, the instructions may include a request for a particular type of data (e.g., engine emissions data, engine knock data, fuel consumption data, etc.). In some embodiments, the instructions may include an authentication credential. For example, the controller 300 may receive the credential and authenticate the user device 200. Authentication of the user device 200 may enable the controller 300 to access the vehicle data. Without authenticating the user device 200, the vehicle data may be securely stored and inaccessible. The authentication credential may be a passkey, a code, a token, and/or other types of credentials.

The vehicle data, such as engine data, includes the vehicle operational data sensed, detected and/or acquired by sensors of the vehicle 190 and may include one or more operational parameters. The operational data packet may also include a vehicle identifier and/or an engine identifier, such as a VIN, a serial number, etc. The operation data packet may also historical data and/or trend data such as sensor data over time, sensor data per mile, sensor data for a route or portion of a route, etc. Accordingly the operation data packet may include time data, location data, route information, operator information, and/or any of the information described herein above. The operational data packet may be generated (e.g., compiled, aggregated, etc.) by the controller 300.

At process 406, the user device 200 transmits a first data packet to the remote computing system 110. The first data packet may include machine-readable and/or computer-readable data. The first data packet includes vehicle operational data, such as engine data, vehicle metadata, such as a vehicle identifier (e.g., a VIN), vehicle location data, and the like. For example, the first data packet may include operational data, such as an engine emissions value (e.g., a NOx output value). The first data packet may also include user device data such as a UID. The UID may include a user device identifier (e.g., a personal computer identifier (PCID)), a user device software identifier, an email address associated with the user device or user device software, and/or other user device data related to the user device 200 and/or a user of the user device 200 (e.g., technician ID who used the user device, etc.). For example, the technician may be required to log onto the user device 200 before a scan is enabled. In which case, the technician ID may be affixed to the extracted data from the scan in order to track who the responsible party was for the scan.

At process 408, the remote computing system 110 analyzes the first data packet. As described above, the remote computing system 110 may analyze the first data packet. In some embodiments, the remote computing system 110 may utilize the engine performance analysis circuit 140 to perform the analysis of the first data packet. The remote computing system 110 advantageously analyzes the actual vehicle performance data provided in the first data packet. In some embodiments, the remote computing system 110 and/or the engine performance analysis circuit 140 may output a second data packet based on the analysis. In some embodiments, the analysis may include determining, based on the first data packet, whether the vehicle operational parameters are within predetermined thresholds. Based on the determining that one or more operational parameters exceeds a threshold (or otherwise do not comply with one or more desired operational ranges, etc.), the remote computing system 110 and/or the engine performance analysis circuit 140 may determine a corrective action to perform. For example, the corrective action may include a repair task, a service task to perform, and/or repair priority information. The repair priority information may include a priority value corresponding to an order of performing repair tasks or service tasks. The remote computing system 110 and/or the engine performance analysis circuit 140 may output the corrective action as the second data packet.

The remote computing system 110 (using the engine performance analysis circuit 140) may determine an identity characteristic of the vehicle 190 and/or a component thereof (e.g., engine 355). The identity characteristic may include a vehicle or component or system identifier and/or an engine configuration of the first vehicle 190 (e.g., based on the metadata that may include a unique identifier), and/or engine operating conditions (e.g., region of travel, geolocation, ambient temperature, etc.). The vehicle identifier may correspond to one or more vehicle characteristics such as a vehicle make, a vehicle model, a vehicle year, etc. The engine configuration may correspond to one or more characteristics or configurations of the engine 355, such as an engine displacement, an engine model, an engine fuel type, and/or other characteristics of the engine. The engine operating conditions may correspond to a geolocation (e.g., a predefined region, a radius from a predetermined location, etc.), ambient temperature conditions/values (e.g., average ambient temperature, maximum ambient temperature, minimum ambient temperature, etc.), engine output values (e.g., engine speed values, engine torque values, etc.), engine emissions values (e.g., a NOx output, etc.), and/or other operating conditions of the engine.

The remote computing system 110 may query the database 130 to identify vehicles or engines that have the same or similar identity characteristic as the first vehicle 190. More specifically, the remote computing system 110 may query the database 130 for at least one vehicle (e.g., a set of vehicles) having at least one identity characteristic that matches the identity characteristic of the first vehicle 190. For example, the remote computing system 110 may query the database 130 for at least one vehicle having the same or similar vehicle identity (e.g., same make and model), engine configuration (e.g., same model of engine which may be based on having the same or similar engine serial number, same displacement, same fuel type, etc.), and/or operating conditions (e.g., operating in the same or similar geolocation areas, operating in the same or similar ambient temperature conditions, etc.). After identifying the at least one vehicle having at least one identity characteristic that matches the identity characteristic of the first vehicle 190, the remote computing system 110 may determine a performance value (e.g., an average performance value, a median performance value, or another value) for the at least one vehicle. In some embodiments, the performance value is at least one of an engine output value (e.g., an engine torque value, an engine speed value, etc.), an engine emissions value (e.g., a NOx output value), and/or other performance value associated with the at least one vehicle having at least one identity characteristic that matches the identity characteristic of the first vehicle 190.

The remote computing system 110 may identify an anomalous parameter based on engineering logic and/or machine learning algorithms. The remote computing system 110 may compare the operational data with the average performance and/or a standardized threshold to identify the anomalous parameter. More specifically, the remote computing system 110 may identify, based on the comparison, one or more parameters outside of the standardized threshold and/or outside a threshold of associated with acceptable performance. In some embodiments, the threshold is based on the determined performance value. For example, the threshold may be a predetermined amount above or below the determined performance value (e.g., within 10% of the performance value). The remote computing system 110 may retrieve, from the database 130, one or more corrective actions based on the anomalous parameter. More specifically, the remote computing system 110 may query the database for one or more corrective actions that may successfully or likely successfully correct the anomalous parameter. In some embodiments, the remote computing system 110 may query the database for one or more corrective actions that correspond to corrective actions used to correct the same anomalous parameter in the at least one vehicle having at least one identity characteristic that matches the identity characteristic of the first vehicle 190. In some embodiments, the remote computing system 110 may query the database 130 for one or more corrective actions based on the at least one identity characteristic that matches the identity characteristic of the first vehicle 190. For example, one or more corrective actions may correspond to one or more identity characteristics (e.g., an engine model, an engine fuel type, a geolocation, etc.).

The remote computing system 110 may identify one or more corrective actions for an identified operational parameter that is outside a threshold for that parameter. The corrective actions may include, but are not limited to: reducing maximum torque amount because the higher torque outputs are leading to more engine knock than a predefined threshold, changing of transmission shift map to reduce shift frequency due to presence of a fault code with transmission, increasing and/or decreasing an amount of reductant dosing to improve NOx conversion of an aftertreatment system, increasing reliance on an electric machine to reduce reliance on ICE (for hybrid vehicles), and/or other corrective actions based on the identified operational parameter that is outside a threshold for the parameter.

In some embodiments, at process 408, the remote computing system 110 is configured to dynamically identify a service provider associated with the first data packet. For example, the remote computing system may determine, based on the UID, a service provider (e.g., a repair/service shop, a vehicle dealership, etc.) that downloaded the operational data packet from the vehicle 190.

At process 410, the remote computing system 110 generates human-readable instructions. The remote computing system 110 is configured to transform the second data packet, which includes machine-readable data into human-readable instructions. In some embodiments, the human-readable instructions include text describing the corrective action to perform. The human-readable instructions are advantageously lower in data size (e.g., compared to the second data packet), such that the transmit time from the remote computing system 110 to another device (e.g., the user device 200) is lower than the transmit time of the first data packet from another device (e.g., the user device 200) to the remote computing system 110. At process 412, the remote computing system 110 transmits the human-readable instructions to the user device 200.

After process 412, the user device 200 may display the human-readable instructions on a display such that a user (e.g., a repair/service technician) may read the human-readable instructions. In some embodiments, the user may access the human-readable instructions via a secure messaging application, such as e-mail, such that the user must input a credential (e.g., a username and password) to access the human-readable message. In other embodiments, the human-readable instructions may be made accessible on an input/output device of the vehicle 190 such that a vehicle operator can view the human-readable message. In yet other embodiments, the human-readable message is provided to both the user device (e.g., via e-mail) and to the input/output device 365 of the vehicle 190 such that both a vehicle operator and a repair/service technician may view the human-readable message, thereby reducing reliance on paper messages to communicate information between the vehicle operator and the repair/service technician. The user may perform the corrective action described by the human-readable instructions on the vehicle 190. In some embodiments, when the corrective action includes repair priority information, the repair/service technician performs the corrective action(s) based on an order defined by corresponding priority values. Alternatively, the corrective actions may be sent to the controller 300 for automatic implementation, without user input (e.g., running a diagnostic).

In some embodiments, the remote computing system 110 and the user device 200 may define a closed loop system for data transfer. Accordingly, data transmitted between the remote computing system 110 and the user device 200 may be encrypted such that only the user device 200 having an associated UID, may decrypt data transmitted by the remote computing system 110.

In some embodiments, the method 400 advantageously includes a coordinated effort between multiple specifically structured computing systems to improve maintenance capabilities. Accordingly the method 400 is advantageously performed in a predetermined time period. For example, a first set of processes involving downloading vehicle data and uploading the vehicle data to the remote computing system 110 (e.g., processes 404 and 406) may be performed in a first predetermined time period (e.g., 1 hour or, more specifically in some embodiments, 45 minutes or less). A second set of processes involving analyzing the vehicle data, by the remote computing system 110 (e.g., process 408) may be performed in a second predetermined time period. In one embodiment, the second predetermined time period is less than the first predetermined time period (e.g., less than 45 minutes, such as 30 minutes or less). A third set of processes involving providing an analytics output, by the remote computing system 110 (e.g., processes 410 and 412) may be performed in a third predetermined time period. In one embodiment, the third predetermined time period is less than each of the first and second predetermined time periods (e.g., 15 minutes or less). A fourth set of processes, including all processes of the method 400, and the corrective actions performed based on the human-readable instructions, may be performed in a fourth predetermined time period that includes the first, second, and third time periods. The fourth predetermined time period may be less than one day, less than 8 hours, and more preferably, 4 hours or less.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used hereinto describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

While various circuits with particular functionality are shown in FIGS. 1 and 2, it should be understood that the remote computing system 110, the user device 200, and/or the controller 300 may include any number of circuits for completing the functions described herein. For example, the activities performed by the engine performance analysis circuit 140 may be distributed into multiple circuits or combined as a single circuit. Additional circuits with additional functionality may also be included. Further, the controller 300 may further control other activity beyond the scope of the present disclosure.

As mentioned above and in one configuration, the “circuits” may be implemented in machine-readable medium storing instructions (e.g., embodied as executable code) for execution by various types of processors, such as the processor 114 of FIG. 1. Executable code may, for instance, comprise one or more physical or logical blocks of computer instructions, which may, for instance, be organized as an object, procedure, or function. Nevertheless, the executables need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Embodiments within the scope of the present disclosure include program products comprising computer or machine-readable media for carrying or having computer or machine-executable instructions or data structures stored thereon. Such machine-readable media can be any available media that can be accessed by a computer. The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing. More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device. Machine-executable instructions include, for example, instructions and data which cause a computer or processing machine to perform a certain function or group of functions.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present disclosure may be written in any combination of one or more other programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone computer-readable package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the apparatus and system as shown in the various exemplary embodiments is illustrative only. Additionally, any element disclosed in one embodiment may be incorporated or utilized with any other embodiment disclosed herein.

What is claimed is:

1. A provider computing system comprising:
a communication interface structured to couple to a network;
one or more processors; and
at least one memory storing instructions that, when executed by the one or more processors, cause the one or more processors to:
receive, from a user device and via the network, a first data packet comprising information associated with a vehicle;
analyze the first data packet to output a second data packet comprising repair priority information;
transform the second data packet into a human-readable message comprising the repair priority information; and
transmit, via the communication interface and the network, the human-readable message to the user device.

2. The provider computing system of claim 1, wherein the information associated with the vehicle comprises at least one of engine performance information, engine load over time information, or a fuel consumption rate.

3. The provider computing system of claim 1, wherein the instructions, when executed, further cause the one or more processors to determine a corrective action based on analyzing the first data packet.

4. The provider computing system of claim 3, wherein the instructions, when executed, further cause the one or more processors to provide the corrective action to a controller of the vehicle such that the controller automatically performs the corrective action.

5. The provider computing system of claim 3, wherein:
the second data packet includes machine-readable data; and
the human-readable message includes only text describing the corrective action.

6. The provider computing system of claim 1, wherein the instructions, when executed, further cause the one or more processors to:
determine an identity characteristic of the vehicle based on metadata included with the first data packet;
query a database for a set of vehicles having at least one identity characteristic that matches the identity characteristic of the vehicle;
determine a performance value for the set of vehicles;
identify one or more parameters of the first data packet that exceed a corresponding threshold, wherein the threshold is based on the performance value; and
retrieve, from the database, a corrective action based on the one or more parameters of the first data packet that exceed the corresponding threshold and the identity characteristic of the vehicle.

7. The provider computing system of claim 1, wherein:
receiving the first data packet occurs within a first predetermined time period from when the first data packet is received by the user device;
analyzing the first data packet occurs within a second predetermined time period from an end of the first predetermined time period, the second predetermined time period less than the first predetermined time period; and
transmitting the human-readable message to the user device occurs within a third predetermined time period from an end of the second predetermined time period, the third predetermined time period less than the second predetermined time period.

8. The provider computing system of claim 1, wherein a data size of the human-readable message is less than a data size of the second data packet.

9. A method comprising:
receiving, by a computing system and from a user device coupled to a vehicle based on receiving an authentication credential that authenticates the user device, a first data packet comprising information associated with the vehicle;
analyzing, by the computing system, the first data packet;
generating, by the computing system and based on analyzing the first data packet, a second data packet comprising repair priority information;
transforming, by the computing system, the second data packet into a human-readable message comprising the repair priority information; and
transmitting, by the computing system, the human-readable message to the user device.

10. The method of claim 9, wherein the information associated with the vehicle comprises at least one of engine performance information, engine load over time information, or a fuel consumption rate.

11. The method of claim 9, further comprising determining, by the computing system, a corrective action based on analyzing the first data packet.

12. The method of claim 11, further comprising providing the corrective action to a controller of the vehicle such that the controller automatically performs the corrective action.

13. The method of claim 11, wherein:
the second data packet includes machine-readable data; and
the human-readable message includes only text describing the corrective action.

14. The method of claim 9, further comprising:
determining an identity characteristic of the vehicle based on metadata included with the first data packet;
querying a database for a set of vehicles having at least one identity characteristic that matches the identity characteristic of the vehicle;
determining a performance value for the set of vehicles;
identifying one or more parameters of the first data packet that exceed a corresponding threshold, wherein the threshold is based on the performance value; and
retrieving, from the database, a corrective action based on the one or more parameters of the first data packet that exceed the corresponding threshold and the identity characteristic of the vehicle.

15. The method of claim 9, wherein:
receiving the first data packet occurs within a first predetermined time period from when the first data packet is received by the user device;
analyzing the first data packet occurs within a second predetermined time period from an end of the first predetermined time period, the second predetermined time period less than the first predetermined time period; and
transmitting the human-readable message to the user device occurs within a third predetermined time period from when end of the second predetermined time period, the third predetermined time period less than the second predetermined time period.

16. The method of claim 9, wherein a data size of the human-readable message is less than a data size of the second data packet.

17. A non-transitory computer readable medium having computer-executable instructions embodied therein that, when executed by at least one processor of a computing system, cause the computing system to perform operations comprising:
receiving a first data packet comprising information associated with a vehicle from a user device;
analyzing the first data packet;
generating a second data packet comprising repair priority information based on analyzing the first data packet;
transforming the second data packet into a human-readable message comprising the repair priority information; and
transmitting the human-readable message to the user device.

18. The non-transitory computer-readable medium of claim 17, wherein the operations further comprise:
determining a corrective action based on analyzing the first data packet, wherein:
the second data packet includes machine-readable data; and
the human-readable message include only text describing the corrective action.

19. The non-transitory computer-readable medium of claim 18, wherein the operations further comprise:
determining that at least one vehicle parameter value of the first data packet exceeds a corresponding threshold, wherein the corrective action corresponds to the at least one vehicle parameter value, and
providing the corrective action to a controller of the vehicle such that the controller performs the corrective action.

20. The non-transitory computer-readable medium of claim 17, wherein a data size of the human-readable message is less than a data size of the second data packet.
